(19) United States
(12) Patent Application Publication
(10) Pub. No.: US 2007/0061849 A1
(43) Pub. Date: Mar. 15, 2007

(54) Systems and methods for processing information or data on a computer

(76) Inventors: Philip M. Walker, Ft. Collins, CO (US); Gabriel B. Beged-Dov, Corvallis, OR (US); Paul Boerger, Ft. Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/224,471

(22) Filed: Sep. 12, 2005

(51) Int. Cl. H04N 7/16; H04N 7/173; H04N 7/18

(52) U.S. Cl. 725/86; 725/81; 725/135

(57) ABSTRACT

Systems and methods are provided for processing information on a computer. In one embodiment, a method is performed by a computer for processing data that is available on the computer. The method processes the data in an ordered fashion, encounters within the data an identification of extra data that is not presently available on the computer, substitutes proxy data in place of the extra data, and processes the proxy data, as though the proxy data were the extra data

### BACKGROUND

Modern network clients, such as Web browsers, iPods, Web-enabled cell phones, and similar devices, can be used to view or listen to multimedia content, and generally are designed to be tolerant of network delays during the transfer of remote files to local cache, and to respond gracefully to pauses and restarts, if necessary, to make the best of the opportunity available with existing network bandwidth. It is possible to begin a listening or viewing experience after a portion of video or audio clip information is buffered, after which downloading and viewing can occur in parallel, greatly reducing the delay that would otherwise be required.

In contrast, some network clients are designed to be intolerant of network latency, in order to avoid some or all of the cost and complexity associated with progressive download capabilities. Such systems are designed to assume that some or all required resources must be available locally at the outset of a multimedia session. A failure to meet these preconditions during a playback session often results in an error condition. A variety of such systems exist, including cell phones, networked game systems, and multimedia players, such as optical disc devices (e.g., CD, DVD, HD, Blu-Ray, etc.).

This type of limitation exists, for example, in the Blu-Ray Audio Visual specification with regard to movie playlists, for example. An entire movie playlist must generally exist in local storage before movie playback can begin.

A Blu-Ray movie playlist contains a list of intervals, represented as IN-points and OUT-points within each of multiple associated video-clip files. These IN-points and OUT-points refer to positions on a time axis of the clip. In effect, the playlist defines the progression of scenes that comprise a video sequence. The Blu-Ray specification requires that a playlist be present in the Blu-Ray virtual file system (a combined overlay of files on the optical disc and the local storage of the Blu-Ray device) before a playback session can begin. This restriction simplifies the playback engine, thereby reducing cost. However, problems arise if an attempt is made, for example, to fast-forward to a clip file that is not yet available locally. The Blu-Ray specification provides that a JAVA exception be generated to notify the application layer program that an error has occurred (e.g., buffer underrun, or similar), but does not specify how the event will or should affect the user experience.

This limitation simplifies the device playback engine by eliminating the need for complex buffering, timeout, and recovery mechanisms associated with robust progressive downloading. However, it also has the potential to diminish the user experience by introducing delays while waiting for all required downloads to finish. Once the Playlist has been loaded into the rendering engine at the outset of a playback session, the only way to avoid a buffer underrun is to ensure that all referenced clip files are present. Current art for responding to a multimedia buffer underrun is to automatically pause the frame, and to provide some indicator of buffer status and user options.

To illustrate in a generic (non-Blu-Ray) example, computers are often utilized to process information that is provided from a remote computer. For example, reference is made to FIG. 1, which is a diagram that illustrates a client computer 10 that is communicatively coupled to a remote computer 20 via a network 30, such as the Internet. In the example presented in FIG. 1, a user of the client computer 10 desires to view a movie—e.g., an MPEG (Motion Pictures Entertainment Group) file 25—that is stored on the remote computer 20. It should be appreciated that, if the movie 25 is a full-length motion picture, for example two hours in length, a significant amount of time would be required if the client computer 110 was first required to download the entire movie before playing it on the client computer 10. Instead, current software minimizes any such delay by permitting what is sometimes referred to as “streaming video.”

Video playback software (for example, MediaPlayer by Microsoft Windows) permit the viewing of video content shortly after the download process begins, by buffering a segment of the video to be displayed. More generically speaking, the client computer 10 includes logic for playing a video, wherein the logic comprises or utilizes a buffer 17 for temporarily storing video content. After invocation of a request to view a video that is stored on the remote computer 20, the client computer 10 causes the initial portion of the movie to be downloaded into the buffer 17. The size of the buffer 17 may vary based on the bandwidth of the connection between the client computer 10 and the remote computer 20, as well as on other factors. In operation, once a sufficient amount of the video content has been loaded into buffer 17, the logic 15 begins to read data out of the buffer 17 and display it on the computer at such a rate that the user may view the content of the movie at a normal viewing speed. As data is being retrieved from the buffer 17, additional data continues to be downloaded across the network 30 and stored in the buffer 17.

Notwithstanding the benefits of the above-described system and operation, certain problems or shortcomings still exist. For example, conditions sometimes referred to as buffer underruns are encountered, whereby the logic 15 has retrieved all of the temporary data stored in the buffer 17, and the system has to wait for additional video data to be downloaded into the buffer 17 before normal video viewing can continue. Such buffer underruns result from any of a variety of reasons, such as high network utilization resulting in a lower bandwidth connection between the client computer 10 and remote computer 20, faulty or intermittent connections between the client computer 10 and remote computer 20, as well as situations in which, for example, the user of client computer 10 may choose to fast-forward to view a location of the movie that has not yet been communicated from the remote computer 20 to the client computer 10. Errors such as these typically do not result in catastrophic failure, but rather result in the freezing of the video display (as observed by the user) until additional data is downloaded to populate the buffer 17, such that normal video play may be resumed.

Reference is made to FIG. 2, which illustrates a similar environment in which a client computer 50 and a remote computer 60 are communicatively coupled via network 70. In the illustration of FIG. 2, the client computer 10 comprises a browser that enables a user of the client computer 10 to access and interact with information stored on remote computers. As is known, a browser is a software application that may be used to locate and display at Web page. Thus, in the context of FIG. 2, the browser 55 enables a user to access and display content 65, stored in the form of a Web page on remote computer 60. Many browsers facilitate the presentation of multimedia information, including graphic images, sound, and video. Typically, such integrated multimedia information is identified by the embedding of links (e.g., hyperlinks), which is an element in an electronic document that links to another place in the same document or to an entirely different document. In the context of a Web page that includes a hyperlink to a video file, the browser 55 located at the client computer must also retrieve the video file 67, in addition to the Web page 65 in order to display the full multimedia content to the user.

As discussed in connection with the example of FIG. 1, reduced bandwidth connections between the client computer 50 and remote computer 60 can result in significant delays of the multimedia content being displayed to the user (particularly as the information to be communicated grows in size). Many browsers 55 handle this situation by first retrieving the Web page and displaying the textual portion (in the context of a multimedia Web page), then supplementing the displayed information with the added multimedia content after it is received. As observed by the user, this is often manifest by a Web page simply having what appears to be missing information. For example, a Web page that includes a photograph, where the image file for this photograph has not yet been received may be presented to the user as simply a blank portion on the screen.

FIGS. 1 and 2 have been provided to illustrate only two (of the many) common situations in which a computer is called upon to perform remote link processing, where information to be processed by the computer is not currently located or available on the computer itself. In the examples illustrated in FIGS. 1 and 2, safeguards have been designed into the system such that catastrophic (e.g., program failure) results do not occur. Instead, the situation is typically manifest, as perceived by the user, as merely an undesirable delay before the information is presented to the user or otherwise processed. In other situations, or context, errors (some catastrophic) may still occur.

### DESCRIPTION OF THE DRAWINGS

The accompanying drawings incorporated in and forming a part of the specification, illustrate several aspects of the present invention, and together with the description serve to explain the principles of the invention. In the drawings:

FIG. 1 is a diagram illustrating components in a prior art system enabling a client computer to retrieve and play a video file stored on a remote computer.

FIG. 2 is a diagram illustrating components in a prior art system enabling a client computer running a browser to display multimedia Web pages.

FIG. 3 is a diagram illustrating components of an embodiment of the present invention.

FIG. 4 is a block diagram illustrating certain components of an embodiment of the present invention.

FIG. 5 is a diagram illustrating the presentation of a Web page running a spreadsheet application, in accordance with an embodiment of the invention.

FIG. 6 is a flow chart illustrating operations of an embodiment of the present invention.

FIG. 7 is a flow chart illustrating operations of an embodiment of the present invention.

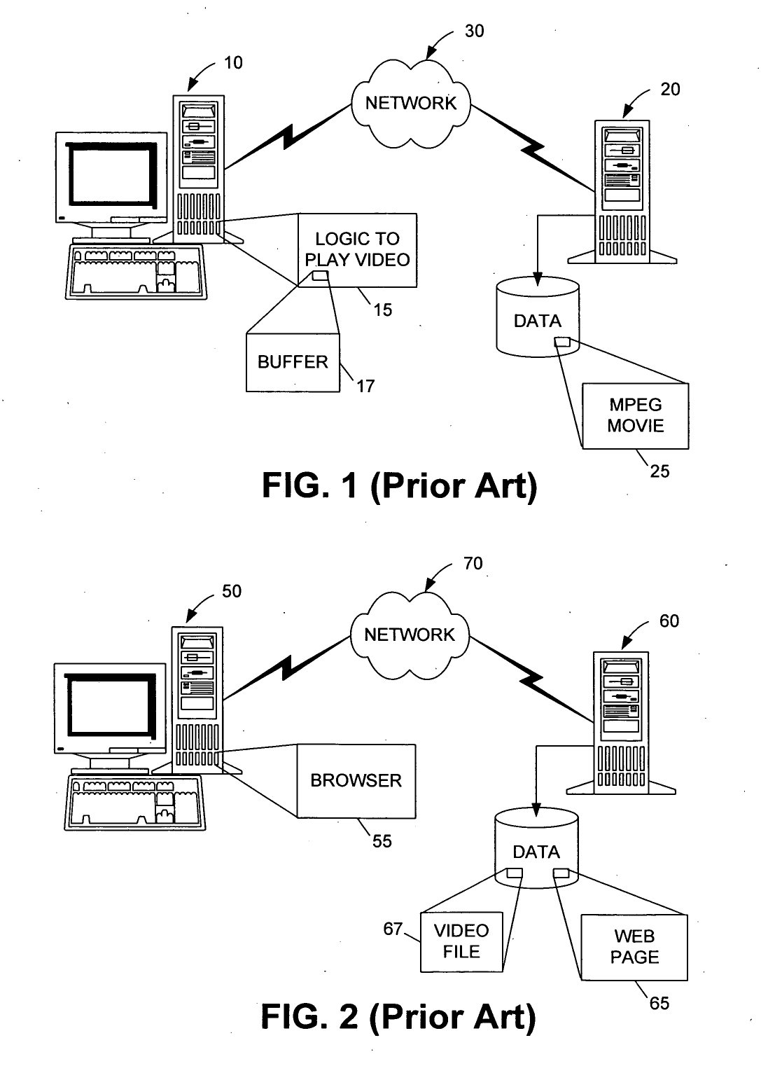

### DETAILED DESCRIPTION

As noted above, prior art systems that perform remote link processing often require that all files to be present (locally) at all times, and further that a low latency random access (to any portion of any file) be provided.

Embodiments of the invention eliminate the latency problem by generating dummy data, as required. In this regard, embodiments present a facade comprising a group of proxy files of the correct sizes, with consistent internal formats, and with consistent internal and external cross-links. Such embodiments provide a way to avoid buffer underrun events during progressive downloads, by ensuring that any file, not fully buffered before it is required, will be provided in the form of a substitute file with sufficient type and characteristics to satisfy the requirements of a latency-intolerant playback engine.

For example, during a movie playback session on a Blu-Ray device, when a clip-file referenced by the current playlist is needed but not yet available, a substitute clip file of the correct size and containing digitized video packets compatible with the current playback codec, etc., will either be synthesized, copied from a pre-existing library of standard substitute files, or generated by making various necessary modifications to a file in a library of substitute files.

In the context of a BD-J Applet running on Blu-Ray device, the necessary substitute files could also be accessed from pre-existing libraries on the BD-J parent disc. This approach lends itself to novel enhancements to the user experience, if the substitute clip contains entertaining content (e.g., cartoon clip of YOSEMITE SAM, or other recognizable character chiding the user for trying to fast-forward during a download, etc.).

In some embodiments, the information used to duplicate the correct names and sizes for the clip files is provided in the playlist, thereby providing the information needed to copy or generate appropriate substitute files, when required. Embodiments of the invention may be embodied in Blu-Ray, as well as non-Blu-Ray, devices. A device, defined by a specification other than Blu-Ray, may require the comparable information to be provided at the outset of a playback session, if it is not already locally available.

The processing of playlists and clip-files in a Blu-Ray device is one exemplary embodiment of the invention, but the use of link synthesis to hide network latency is also applicable in other contexts. Other examples of applications involving processing of cross-linked file groups include cross-linked text documents, spreadsheet files, and especially those based on Web standards (HTML, XML, ASP, PHP, CGI, etc).

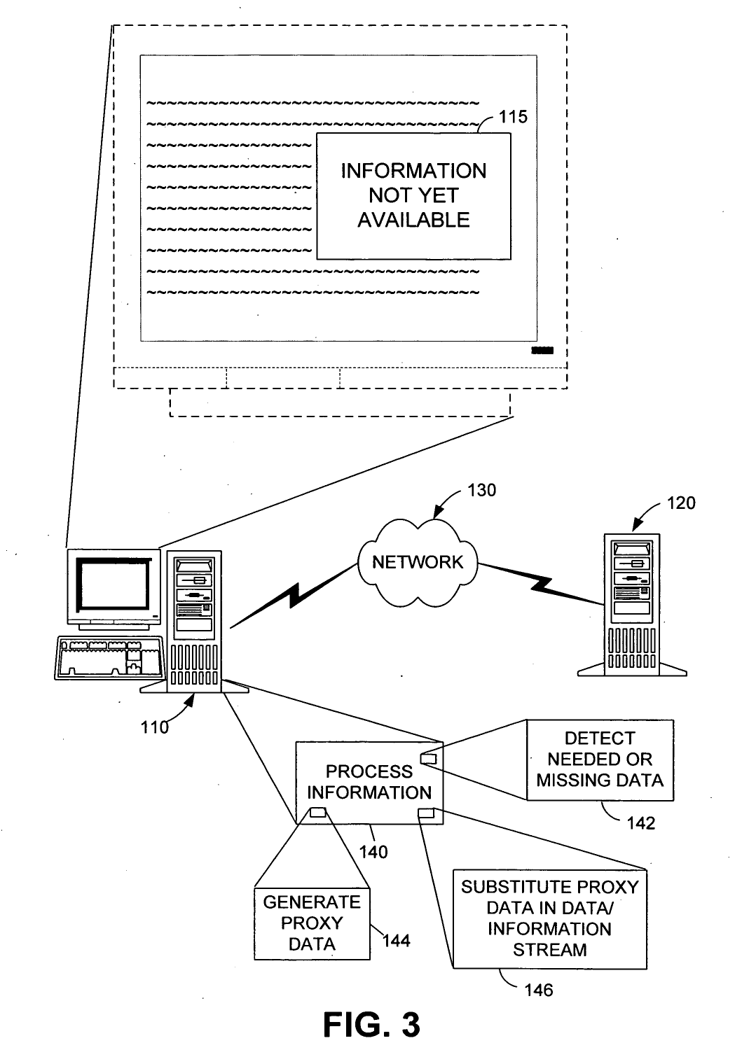

Reference is now made to FIG. 3, which is a diagram illustrating certain components utilized in an embodiment of the present invention. This embodiment comprises a client computer 110 and a remote computer 120, which are communicatively coupled across a network 130. Software or other logic 140 is provided on the client computer 110 for processing information. As used herein, processing information encompasses a broad category of activities, which include, but are not limited to, displaying graphics and/or video, processing and/or displaying a Web page, executing a software application (e.g., a MICROSOFT WORD, EXCEL, POWERPOINT, etc. application), etc. The information to be processed may be stored or accessible locally by the client computer 110, or may be stored remotely and communicated to the client computer 110 across the network 130 or other communication channel.

Whether the information is predominately stored locally or remotely, often there are links or some other internal reference to information or data not available on the client computer 110. Embodiments of the present invention provide systems and methods for handling such situations. In this regard, the embodiment of FIG. 3 operates to substitute proxy data in place of referenced or missing data (also referred to herein as extra data) that is otherwise not available on the client computer 110. In accordance with embodiments of the invention, proxy data comprises data of the same type, format, or compatibility as the referenced or missing data. This enables the system to continue processing without incurring errors or undue delay because certain referenced information or data is not currently available. In one embodiment, this functionality is accommodated by providing logic 142 for detecting extra data from the information that is being processed by the client computer 110. This logic 142 may operate and be implemented in any of a variety of ways. In one embodiment, the logic 142 operates to identify a link (e.g., a pointer, address, hyperlink, etc.) that is embedded within the information, and which points to or references data that is not a part of the information, or which references or implicates data that is otherwise presently available on the client computer 110.

Such referenced or missing data may come in a variety of forms. For example, a multimedia Web page may contain internal graphics or may contain a link within the Web page information to a file or location where the graphics information is located. As another example, an application program, such as WORD, may include one or more embedded objects (e.g., sound clip, graphics file, video clip, etc.). This embedded information may be referenced or identified by an internal link within the WORD document. A variety of other examples exist in which information may contain a reference to external information. The logic 140, when processing the information, would also process the extra data that is referenced from within the information or the information stream.

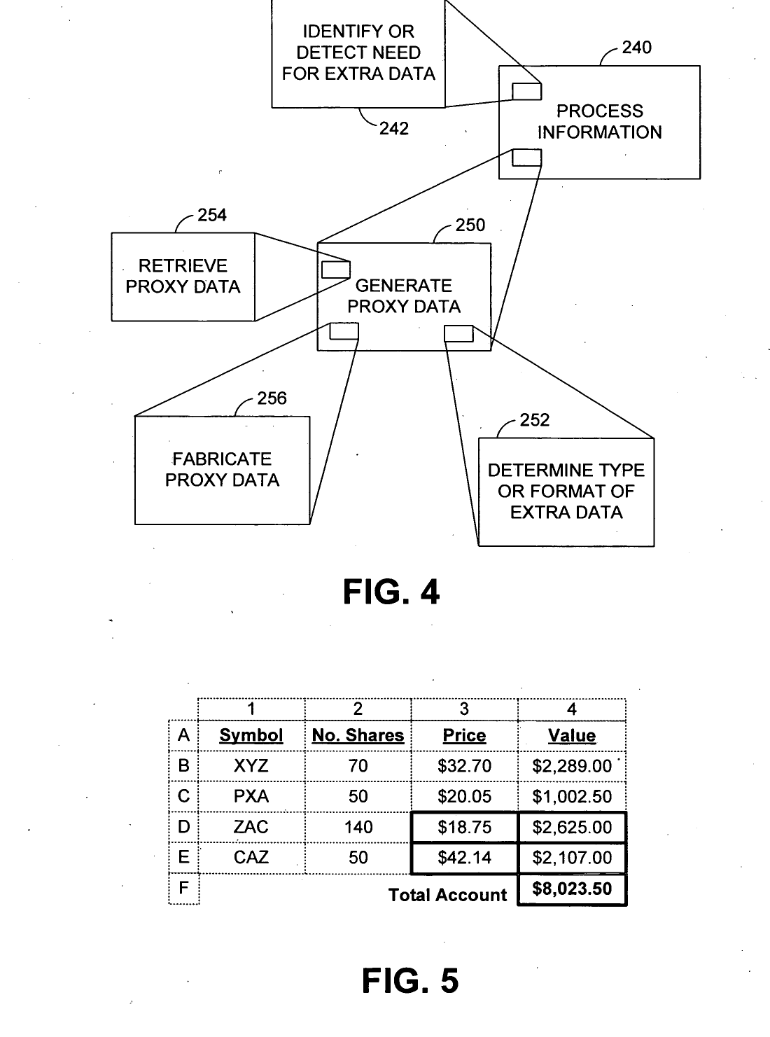

In keeping with the embodiment of FIG. 3, logic 144 is also provided to generate proxy data, which is to be processed (at least temporarily) in place of the extra data identified by logic 142, as being needed or otherwise missing from the information currently available to client 110. As the name implies, proxy data is data that is appropriate for substitution in place of the original data, in the relevant context. For example, if the extra data is a video file, then the proxy data in one embodiment would be in the form of a video file or video clip. Likewise, if the original data was numerical data for utilization in a spreadsheet application, then the proxy data would be data suitable for use in a similar context. Consistent with the scope and spirit of the invention, there are a variety of ways in which the proxy data may be generated. Examples of ways of generating the proxy data will be discussed in further detail in connection with FIG. 4.

The embodiment of FIG. 3 further comprises logic 146 that is configured to substitute the generated proxy data in place of the extra data identified as missing within the information stream provided from computer 120 or from within the information that is otherwise currently available at client computer 110. The processing logic 140 then processes this substituted proxy data, along with the remainder of the information as though the proxy data were effectively the original data.

From the standpoint of a user of the client computer 110, the processing of the information is relatively seamless. In some embodiments (depending upon the context and/or sensitivity of the data), there may be no visible or perceptible difference between the results of processing original versus proxy data. In other embodiments, however, visual information (of various forms) may be presented to the user to alert the user that proxy data has been temporarily substituted. For example, consider a user operating a browser and selecting a multimedia Web page that includes a window of embedded video. The remainder of the Web page may be retrieved and displayed by the browser to the user, and a short video clip generated by logic 144 may be substituted into the multimedia Web page for display to a user, until the original data is communicated to the client computer 110. As illustrated in FIG. 3, such a window 115 may include a message such as “information not yet available.” This information may be either stored locally, or generated on the fly by logic 144, and prepared in an appropriate video file format, such that it can be seamlessly integrated into the multimedia Web page in the same way that the original video information will be integrated within the remainder of the Web page information. Later, after the original/extra data is received, it is substituted in place of the previously substituted proxy data.

Reference is now made to FIG. 4, which is a block diagram illustrating certain features of an embodiment of the present invention. As described in connection with FIG. 3, certain embodiments of the present invention include a client computer that comprises logic 140 for processing information. The information may largely preexist on the client computer 110, or may be provided in the context of an information stream from a remote computer 120. As noted above, the logic 140 for processing information may take on any of a variety of forms. FIG. 4 illustrates logic 240 that is configured to process information in a way that loosely corresponds to the logic 140 of the embodiment of FIG. 3. The logic 240 comprises logic 242 that is configured to identify or otherwise detect a need for extra data that is not currently available on the client computer and has not been communicated as a part of an information stream from a remote computer. In response to the logic 242 identifying a need for extra data, logic 250 generates appropriate proxy data for substituting in place of the missing data in the information or information stream. In one embodiment, the logic 250 comprises logic 252 that is configured to determine the type or format of the extra data. For example, and keeping with the illustrations previously presented herein, the extra data could be in the form of a graphics file (such as a JPEG, TIFF, bitmap, or other graphics file format), a video file (such as MPEG, AVI, etc.), etc. In situations where missing data is identified by a link or pointer to an external file, the type or format of the missing data may be readily determined simply by the information contained within the pointer (e.g., the file extension of the file name that the pointer or link identifies). In other situations, the type or format of the extra data may be ascertained from the context in which the missing or extra data is identified. For example, in a situation in which the logic 240 is processing an spreadsheet, and reference is made during the computation of a formula to a cell of another spreadsheet, certain information regarding the type or format of the data may be ascertained from the context of the computations that are being performed, which call for or link to the extra data.

In the embodiment of FIG. 4, the logic 250 may further comprise logic 254 for retrieving proxy data and/or logic 256 for fabricating proxy data. After the logic 252 has made a determination of the type or format of the extra data that is needed, this information can be used by logic 254 for retrieving proxy data. In this regard, the client computer may have a database of varying types of proxy data that is preformed and may be readily retrieved for substitution into information streams, in accordance with embodiments of the present invention. That is, certain video files, graphic image files, data files, etc., may be pre-formed and readily available for use by embodiments of the invention. In addition, or in some embodiments in the alternative, logic 256 is utilized to fabricate proxy data on the fly. After a determination is made as to the type and/or format of proxy data that is needed, logic 256 may be configured to readily generate such data. In some embodiments, logic 256 operates in response to metadata that is provided by the remote computer or by the application that identifies or invokes the missing data.

As one example of an embodiment in which a remote computer may supply metadata that a client computer uses for generating proxy data, consider a Web page host that supplies stock market information through a spreadsheet application program (such as Microsoft Excel). A user may log on to the Web page, using a client computer. The Web page host, recognizing the user's log in, supplies information to the user regarding the user's account. To facilitate this example, reference is made to FIG. 5, which illustrates exemplary information in a layout that may be presented to the user in spreadsheet form. The illustrated spreadsheet includes row identifiers A-E and column identifiers 1-4. In the example, four hypothetical stocks are illustrated by ticker symbols XYZ, PXA, ZAC, and CAZ. In the second column, the number of shares of each respective stock held by the user's account is presented. In the third column, the current price per share is presented, and in the fourth column the current value of each stock in the user's account is shown. Although there are a variety of ways this information may be supplied to the user, assume, for purposes of this example, that the host Web page returns the name and number of shares to the user's computer. In the price column, assume that embedded links are provided, which reference a different spreadsheet or data location that are accessed to provide the individual stock prices at a given moment in time. Finally, in the value column of column 4, the spreadsheet includes formulas such that the values in rows B-E is equal to the number of shares in column 2 multiplied by the current price of column 3. Also, cell F4, which displays the total value of the user's account, an equation which includes a summation of cells B4-E4 is provided.

Therefore, the initial information provided by the Web page to the user is the name and number of shares for each stock in the user's account. As the price column merely contains links, the data for that column is not yet available for display. Likewise, the data to be displayed in the value column (column 4) is not yet available, either. In accordance with an embodiment of the invention, proxy data is retrieved or generated at the client computer to insert in place of the price values of column 3 (until the actual data is received from the Web host). In the embodiment of this example, metadata is also provided by the Web host along with the initial transfer of data for this information supplied in columns 1 and 2. This metadata is not visible to the user, but supplies information to the user's application (e.g., the Microsoft Excel spreadsheet application), which provides information to the application so that appropriate proxy data may be generated for the links that are embedded in the price column, as well as the undefined data that would result in the formula cells of column 4 (the undefined data being a formula that references a cell that does not yet have a valid value). In embodiments of the invention, a visible representation is provided to notify a user of an output or outcome that results from the processing of proxy data. This may be done in a variety of ways, such as highlighting the resulting output, providing the resulting output in a distinct color, etc.

As many application programs, such as EXCEL, are not designed to look for such metadata, plug-ins or other alterations to these programs may be supplied from the Web host. For example, when the user initially sets up his or her account with the web host, the Web host may provide a plug-in for the user's computer such that in later interactions between the application program of the user's computer and the Web host, the application program looks for this metadata and controls the operation of the application program accordingly.

In keeping with the example of FIG. 5, the current price value of rows B and C have been retrieved, but the current price values of rows D and E have not yet been retrieved. Accordingly, rather than display some sort of error (or even possibly crash the operation of the program), the embodiment generates proxy data to supply in these columns. In one embodiment, the proxy data may be saved on the user's computer as the last retrieved values for these columns. The substitution of proxy data may be emphasized to the user by highlighting those particular cells (highlighting illustrated in FIG. 5 by a border provided around the cells). In another embodiment, the substitution of proxy data may be emphasized by presenting the data in inverse or different colors. In this way, proper numerical values are supplied to the spreadsheet application program in place of the embedded links, so that the formulas of the value column (column 4) are computed without error, while at the same time alerting the user that the data or information output may not be reliable and is subject to change, after receiving the original data.

The foregoing example has been presented to illustrate just one of a large variety of situations in which proxy data may be retrieved or generated and substituted in place of missing or extra data, in accordance with embodiments of the present invention.

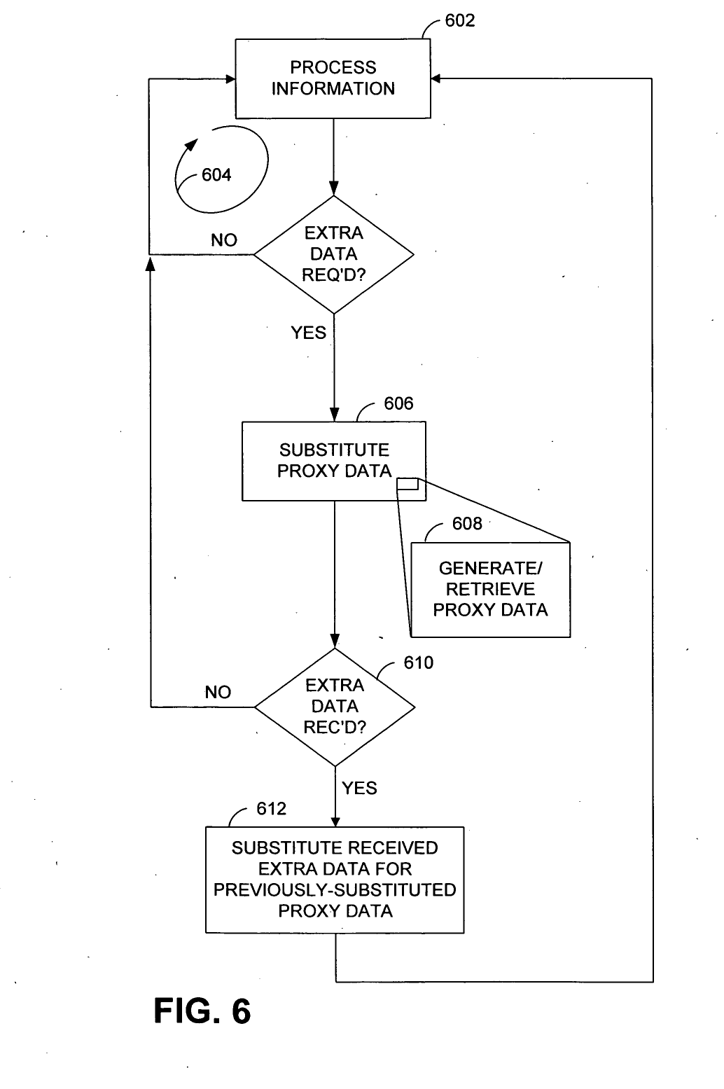

Reference is now made to FIG. 6, which is a flow chart illustrating a top-level operation of an embodiment of the invention. In this embodiment, information is processed at a client computer. As described above, this information may be stored on a client computer and processed in an ordered fashion, or may be received in the form of an information stream provided from a remote computer and processed in a generally sequential value (as received) 602. If the information is complete, then the processing continues in a conventional fashion, as denoted by loop 604. If, however, extra data is required (e.g., data that is missing or otherwise not available at the client computer), then the method operates to substitute proxy data 606 in place of the extra or missing data. As described above, this proxy data may be retrieved from a known stored location, which is available at the client computer, or alternatively may be generated on the fly 608.

As illustrated in block 610, as extra data is received from a remote computer (or as it otherwise becomes available to the client computer), which extra data had been previously replaced by proxy data, then the received (or newly available) extra data is substituted for the previously substituted proxy data 612.

It should be appreciated that the flow chart of FIG. 6 is presented to illustrate certain functional steps and/or operations, but that the specific implementation may vary among embodiments of the invention. Indeed, the detection of the receipt of extra data is illustrated by decision block 610, which has been placed serially below block 606. In practice, however, the receipt of extra data may trigger an interrupt that leads to the substitution called for in block 612 (as opposed to performing a specific check or evaluation for this data in a sequential loop, as illustrated).

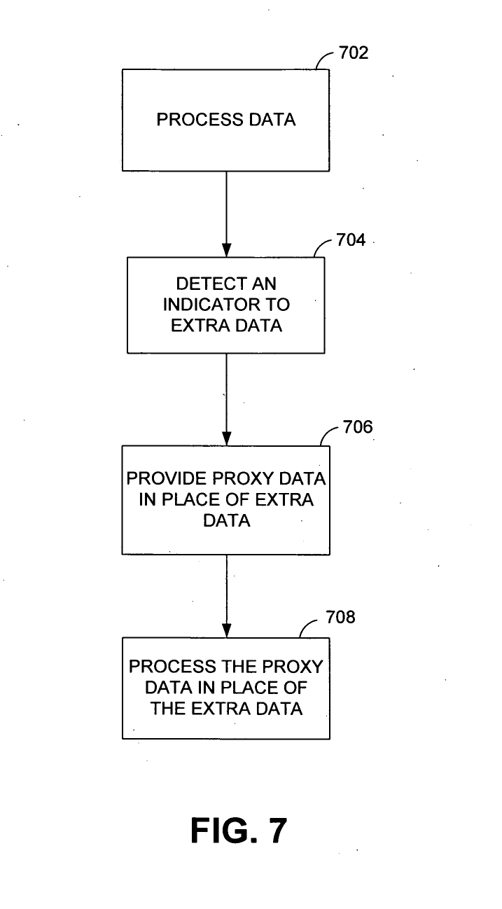

Reference is now made to FIG. 7 which is a flow chart illustrating a top-level operation of another embodiment of the invention. In the embodiment of FIG. 7, data from an information source or information stream is processed. As described above, such processing includes the execution of an application program, the presentation of graphics, the display of a video stream, etc. During the course of processing data, the method detects an indicator to extra data 704, which is data that is not currently available to the processing computer. In response, the processing computer provides proxy data 706 in place of the extra data, and then processes the proxy data 708 in place of the extra data. As described herein, the proxy data may be prefabricated and stored at the processing computer, or alternatively may be generated on the fly. With regard to the generation of proxy data, the proxy data may be generated based upon metadata provided by a remote computer, or alternatively may be generated based upon an evaluation (by the processing computer) of the context in which the extra data is encountered or needed. Such context may include the type or format of data called for, the application that will process the extra data, and other criteria that vary from embodiment to embodiment.

Any process descriptions or blocks in flow charts should be understood as representing modules, segments, or portions of code which include one or more executable instructions for implementing specific logical functions in the process, and alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention.

What is claimed is:

1. A method performed by a computer for processing data that is available on the computer comprising:
processing the data in an ordered fashion;
encountering within the data an identification of extra data that is not presently available on the computer;
substituting proxy data in place of the extra data; and
processing the proxy data along with the data, as though the proxy data were the extra data.

2. The method of claim 1, wherein the processing the data more specifically comprises processing the data in a generally sequential fashion.

3. The method of claim 1, wherein the method more specifically comprises processing data from a Blu-Ray device.

4. The method of claim 1, further comprising:
receiving the extra data by the computer;
substituting the received extra data in place of the previously substituted proxy data; and
processing the substituted extra data.

5. The method of claim 1, further comprising retrieving proxy data from the computer.

6. The method of claim 1, further comprising generating the proxy data from metadata that is embedded within the data.

7. The method of claim 1, further comprising generating proxy data that is in a consistent format with the extra data.

8. The method of claim 1, wherein the encountering an identification of extra data comprises detecting a link to the extra data.

9. A method for processing information received from a remote computer comprising:
processing data comprising a portion of the information received;
detecting an indicator to extra data not stored locally;
providing proxy data in place of the extra data; and
processing the proxy data in place of the extra data, as though the proxy data were the extra data.

10. The method of claim 9, wherein the detecting an indicator to the extra data comprises detecting a link to data that has not yet been received from the remote computer.

11. The method of claim 9, wherein the processing data comprises displaying a form of the data.

12. The method of claim 9, wherein the providing proxy data comprises providing metadata as a portion of the information being received and generating the proxy data from the metadata.

13. The method of claim 9, further comprising replacing the proxy data with the extra data, after the extra data is received.

14. A method for processing data in an information stream received from a remote computer comprising substituting proxy data in place of data referenced in the information stream, but not currently stored locally, and processing the proxy data in place of the data not stored locally.

15. The method of claim 14, wherein the processing data in an information stream further comprises displaying information stored in a file.

16. The method of claim 14, wherein the substituting proxy data further comprises replacing the data referenced, but not currently stored locally, with other data suitable for processing in context of surrounding data.

17. The method of claim 14, further comprising replacing the proxy data with the data referenced, after the data referenced is received.

18. A system for processing information received from a remote computer comprising:
logic configured to process portions of the information as the portions are received;
logic configured to detect a link to missing information not stored locally; and
logic configured to substitute proxy data in place of the missing information.

19. The system of claim 18, further comprising logic configured to replace proxy data with the missing information, after the missing information is received by the system.

20. The system of claim 18, wherein the remote computer comprises a Blu-Ray device.

21. A system for processing data on a computer comprising:
logic configured to receive data to be processed;
logic configured to process the data generally as it is received;
logic configured to identify extra data that is referenced in the received data, but which is not presently available on the computer;
logic configured to substitute proxy data in place of the extra data; and
logic configured to process the proxy data.

22. The system of claim 21, further comprising logic configured to generate the proxy data from metadata that is embedded within the received data.

23. The system of claim 21, further comprising logic configured generating proxy data that is in a consistent format with the extra data.

24. The system of claim 21, wherein the logic configured to identify extra data comprises logic configured to detect a link to the extra data.

25. A system for processing data in an information stream comprising:
means for substituting proxy data in place of data referenced in the information stream not currently stored locally; and
means for processing the proxy data in place of the data not stored locally.
